(19) United States
(12) Patent Application Publication
(10) Pub. No.: US 2007/0257873 A1
(43) Pub. Date: Nov. 8, 2007

(54) BRIGHTNESS CONTROL OF A LIGHTING UNIT OF A MATRIX DISPLAY DEVICE

(75) Inventors: Haeng Seon Kim, Singapore (SG); Siong Tee Tan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,280

(22) PCT Filed: Sep. 28, 2005
(86) PCT No.: PCT/IB05/53202

§ 371 Date: Mar. 29, 2007

(30) Foreign Application Priority Data
Oct. 4, 2004 (EP) 04104855.4

(51) Int. Cl. G09G 3/36

(52) U.S. Cl. 345/87

(57) ABSTRACT

A brightness control circuit (1) for a lighting unit (2) of a matrix display unit (3) having transmissive or reflective pixels (Pi) is disclosed. The brightness control circuit (1) comprises an integrator (10) to integrate color component signals (R, G, B) of an input image signal (IS) to be displayed on the matrix display unit (3) to obtain integrated signals (IR, IG, IB). A selector (11) supplies the one of the integrated signals (IR, IG, IB) having a highest level to the lighting unit (2) to obtain a brightness of the lighting unit (2) depending on said highest level.

### FIELD OF THE INVENTION

The invention relates to a brightness control circuit for a lighting unit of a matrix display device, a display apparatus comprising such a brightness control circuit, and a method of controlling a brightness of a lighting unit of a matrix display device.

### BACKGROUND OF THE INVENTION

The patent application US2002/0122020-A1 discloses an apparatus and method for automatic brightness control of a backlight in a liquid crystal display device (further also referred to as LCD device). The LCD device generates a brightness control signal for the backlight in response to a duty rate signal. The duty rate signal has a duty cycle which corresponds to an average gray level and/or a color state of image data to be displayed on the LCD device. The image data is represented by R, G and B signals, which indicate the amount of red, green and blue per input pixel in the image data, respectively.

If the duty cycle corresponds to the color state of the image data, the maximum duty cycle depends on the sum of values in R, G and B registers. The G signal contributes fully to the R and B registers, the R signal contributes with 66% to the G and B registers, and the B signal contributes with 49% to the R and G registers. The sum of all the values in the R, G and B registers determines the duration of a high level of a pulse of the duty rate signal. The brightness of the backlight is proportional to the duration of the high level of the pulse. This approach is used to reduce a brightness magnitude in the order of G, R, B so that the contrast for each picture displayed on the LCD display screen is improved and the power consumption is decreased. It is disclosed that the effect is that in a dark picture (black) the brightness is lower than in conventional technique, and in a light picture (white) the brightness is the same as in conventional technique.

This automatic brightness control of the backlight may be combined with a user controlled setting of the brightness.

It is a drawback of this known automatic brightness control that for particular images, the brightness of the backlight is not optimal.

### SUMMARY OF THE INVENTION

It is an object of the invention to provide an automatic brightness control for a lighting unit of a matrix display device with an improved performance.

A first aspect of the invention provides a brightness control circuit as claimed in claim 1. A second aspect of the invention provides a display apparatus as claimed in claim 4. A third aspect of the invention provides a method of controlling brightness of a lighting unit as claimed in claim 5. Advantageous embodiments of the invention are defined in the dependent claims.

The brightness control circuit for the lighting unit of the matrix display comprises an integrator which integrates the color input signals (usually the red, green and blue component signals R, G, B) of an image signal to be displayed on the LCD to obtain corresponding integrated signals. A time constant of the integrator is larger than the pixel repetition frequency of the image pixels of the color input signals. Preferably the time constant is equal or larger than a frame period of the image signal.

A selector supplies the one of the integrated signals which has the highest level to the lighting unit to generate a brightness which depends on this integrated signal which has the highest level. The brightness of the lighting unit can be optimally controlled because the momentary highest level of the color input signals is used separately. In contrast, the automatic brightness control disclosed in US2002/0122020, always uses a sum of averaged input signals R, G, B to control the brightness of the backlight unit and does not use the averaged input signal which has momentarily the highest level.

Preferably, the brightness produced by the lighting unit is proportional to the level of the integrated signal which has the highest level. Such a brightness control of a lighting unit which is performed automatically based on the video input signal is also referred to as the automatic brightness control. An optional user controlled brightness control may also be implemented.

If the matrix display comprises transmissive pixels which modulate their transmission, and the matrix display is located in-between the viewer and the lighting unit, usually, the lighting unit is also referred to as the backlight or backlight unit.

The embodiment as defined in claim 2 provides a simple circuit to generate a control signal for the lighting unit. The control signal varies with the level of the integrated color input signal which (momentarily) has the highest level.

In the embodiment as defined in claim 3, the control signal supplied to the lighting unit is the one of following levels which has the highest level (i) the user controlled level or (ii) the integrated signal which has the highest level of all the integrated signals. Thus, if the user controlled brightness level is relatively high, only a small range is available for the automatic brightness control based on the highest one of the integrated signals. But, if the user controlled brightness level is relatively low, a large range is available for the automatic brightness control using the integrated signal with the highest momentary level. This has the advantage that the available brightness range is optimally used by the automatic brightness control.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a display apparatus which comprises the brightness control circuit in accordance with the invention,

FIG. 2 shows a more detailed circuit diagram of the selector in accordance with the invention, and

FIGS. 3A and 3B show signals elucidating the operation of the selector shown in FIG. 2.

### DETAILED DESCRIPTION OF THE PREFERRED EMBODIMENT

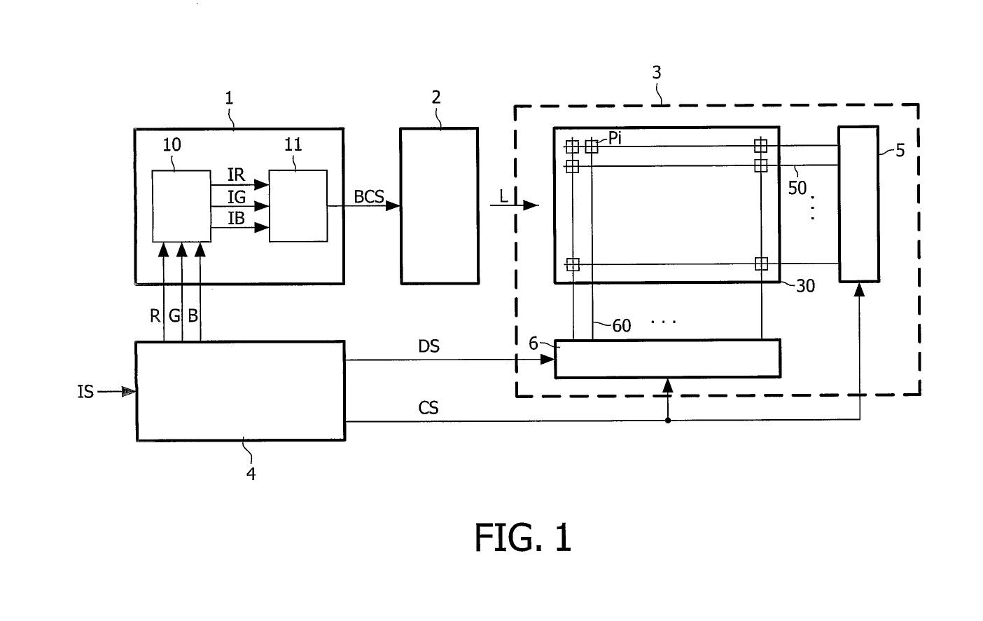

FIG. 1 shows a block diagram of a display apparatus which comprises the brightness control circuit in accordance with the invention. The display apparatus comprises a brightness control circuit 1, a lighting unit 2, a reflective or transmissive matrix display unit 3 and an image processing circuit 4.

The matrix display unit 3 comprises a matrix display 30, a select driver 5, and a data driver 6. The matrix display 30 comprises an array of pixels Pi at intersections of select electrodes 50 and data electrodes 60. The pixels Pi may be LCD cells, or any other cell which is able to modulate an amount of impinging light. The cells may modulate their transmission (for example LCD) or their reflectivity (for example DMD). In a multi-colored matrix display, the cells may modulate different colors light, for example, by using different color filters (for example for LCD cells) in front of adjacent cells which have an identical structure, or different colored particles (for example for electrophoretic cells) per cell.

The select driver 5 supplies select voltages to the select electrodes 50. The data driver 6 supplies data voltages to the data electrodes 60. Usually, the select electrodes 50 are selected one by one and the data voltages are supplied in parallel via the data electrodes 60 to the line of pixels Pi associated with the selected select electrode 50. However, the present invention is not limited to this particular drive of the matrix display 30. For example, several lines of pixels Pi associated with several select electrodes 50 may be selected at the same time to receive the same data voltages per data electrode 60.

The lighting unit 2 comprises a light source (not shown) which generates light L which is directed towards the matrix display 30 to illuminate the pixels Pi. Usually, for transmissive matrix displays the lighting unit 2 is positioned at the back side of the matrix display 30, such that the matrix display 30 is in-between the viewer and the lighting unit 2. For reflective matrix displays the lighting unit 2 may have a position in front of the matrix display 30 to reflect the light back to the viewer via the matrix display 30 dependent on a reflective status (for example angle) of the cells. Usually, the light source is a gas-discharge lamp.

The image processing circuit 4 receives the input image signal IS which has to be displayed on the matrix display 30. This image signal IS may comprise static or dynamic image information. In the latter case the image signal IS is generally referred to as a video signal. The image processing circuit 4 supplies color input signals R, G, B, which usually are called red (R), green (G), and blue (B) component signals, also referred to as RGB signals, to the brightness control circuit 1. The image signal IS may already comprise these red, green and blue component signals. Alternatively, the image signal IS may comprise the Y (luminance) and U, V (chrominance) signals. If the RGB signals are available in the image signal IS they can be directly fed to brightness control circuit 1 as the color input signals R, G, B. Otherwise the image signal IS has to be processed to obtain the RGB signals. The image processing circuit 4 further generates the input data signal DS which is supplied to the data driver 6, and control signals CS which control the synchronized operation of the select driver 5 and the data driver 6. The input data signal DS is also based on the RGB signals. Usually, depending on the structure of the pixels Pi, a processing is required to make the RGB signals suitable for driving the corresponding pixels Pi.

The brightness control circuit 1 in accordance with the present invention comprises an integrator 10 which integrates the color input signals R, G, and B to obtain the integrated signals IR, IG, and IB. Preferably, the integrating time constant is selected to be at least one frame period. A selector 11 supplies the one of the integrated signals IR, IG, 1B which has the highest momentary level to the lighting unit 2 as the lighting unit control signal BCS. The lighting unit 2 generates a brightness which is proportional to the lighting unit control signal BCS in that the brightness increases if the highest average level increases. Preferably, the brightness of the lighting unit 2 is proportional to the lighting unit control signal BCS.

It has to be noted that the average values of the integrated signals IR, IG, IB are fluctuating depending on the actual image content of the image displayed. It is thus possible that within a same frame period different integrated signals IR, IG, IB have successively the highest level. The brightness of the lighting unit 2 is always determined by the one of the integrated signals IR, IG, IB which has the highest level. Thus, the lighting unit 2 is always able to supply the highest brightness possible for the actual image being displayed.

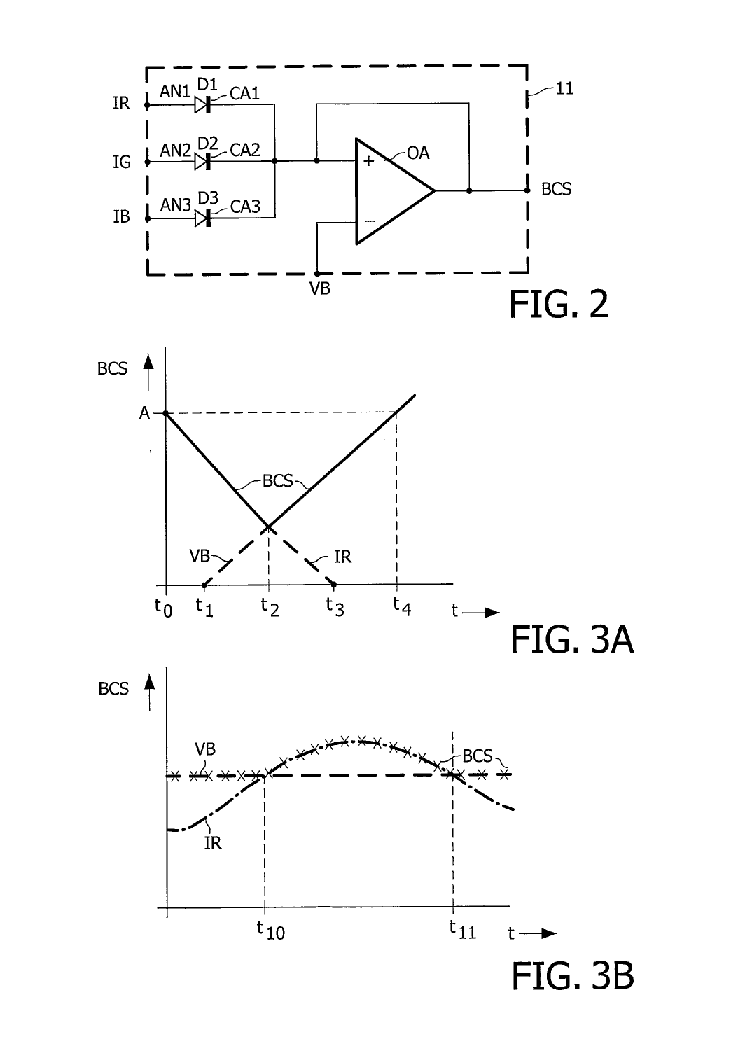

FIG. 2 shows a more detailed circuit diagram of the selector in accordance with the invention. The selector 11 comprises an operational amplifier OA which has an inverting input—to receive a reference voltage VB, a non-inverting input+, and an output connected with the non-inverting input+. The output supplies the lighting unit control signal BCS to the lighting unit 2 to control the brightness of the lighting unit 2.

A rectifier D1 has a cathode CA1 coupled to the non-inverting input+ and an anode AN1 which receives the integrated signal IR, a rectifier D2 has a cathode CA2 coupled to the non-inverting input+ and an anode AN2 which receives the integrated signal IG, and a rectifier D3 has a cathode CA3 coupled to the non-inverting input+ and an anode AN3 which receives the integrated signal IB. The operation of the selector shown in FIG. 2 will be elucidated with respect to FIGS. 3A and 3B.

FIGS. 3A and 3B show signals elucidating the operation of the selector shown in FIG. 2. Both FIGS. 3A and 3B show the level of the lighting unit control signal BCS at the output of the operational amplifier OA as function of time t dependent on the level of the voltage VB at the inverting input—and the level of the integrated signal IR at the anode AN1 of the rectifier D1. It is assumed that the level of the integrated signal IR is the highest of all the integrated signals IR, IG and IB. Consequently, the other diodes D2 and D3 are blocked.

FIG. 3A shows the level of the lighting unit control signal BCS at the output of the operational amplifier OA for varying levels of the integrated signal IR and the voltage VB. To facilitate the explanation it is assumed that the integrated signal IR drops linearly from a starting value A at the instant t0 to the level zero at the instant t3. The level of the voltage VB rises linearly, starting from the level zero at the instant t1 up to the level A at the instant t4 which is later than the instant t3. It has to be noted that the non-inverting input+ and the output of the operational amplifier OA are interconnected. Thus, the level of the lighting unit control signal BCS is identical to the level of the non-inverting input of the operation amplifier OA. Further, for the ease of elucidation it is assumed that no voltage drop occurs across the rectifiers D1 to D3 if they are in the conductive state. Further is assumed that the amplification factor of the operational amplifier OA is very high such that in a stable state the voltages at the inputs of the operational amplifier OA must be identical.

Consequently, as long as the level of the voltage VB is higher than the levels of all the integrated signals IR, IG, and IB, separately, the diodes D1 to D3 will be blocked and the level of the lighting unit control signal BCS follows the level of the voltage VB. If a user controls the brightness setting and thus the level of the voltage VB, the varying level of the voltage VB causes the lighting unit control signal BCS to vary in the same manner and thus the brightness generated by the lighting unit 2 varies in accordance with the user brightness setting.

On the other hand, as long as the level of the integrated signal IR is higher than the level of the voltage VB, the level of the integrated signal IR is supplied as the lighting unit control signal BCS. Consequently, more in general, as long as the level of the highest one of the integrated signals IR, IG, IB is above the user set level of the voltage VB, the brightness of the lighting unit 2 is controlled with the level of the highest one of the integrated signals IR, IG, IB, automatically. At relatively low settings of the level of the voltage VB, the range available for the automatic control of the brightness of the lighting unit 2 is larger than at relatively high settings of the level of the voltage VB.

In FIG. 3B is shown how the lighting unit control signal BCS varies as function of time if the level of the voltage VB is constant and the integrated signal IR, which has the highest level of all the integrated signals IR, IG, IB, varies. The resulting lighting unit control signal BCS is indicated by small crosses. Until the instant t10 and after the instant t11, the level of the voltage VB is higher than the level of the integrated signal IR and thus the level of the lighting unit control signal BCS is identical to this adjustable level set by the brightness control controlled by the user. From the instant t10 to t11, the level of the integrated signal IR is higher than the set level of the voltage VB. Now, the level of the lighting unit control signal BCS follows the varying level of the integrated signal IR. The brightness of the lighting unit 2 is controlled with the level of the lighting unit control signal BCS, thus the brightness increases between the instants t10 and t11 in accordance with the waveform with which the integrated signal IR varies.

Usually, the brightness of the lighting unit 2 is limited to a predetermined maximum. If the lighting unit control signal BCS reaches a maximum control level corresponding to this maximum level of the brightness, a further increase of the control level will have no effect on the brightness of the lighting unit 2. Thus, if the user brightness control is set to maximum and the level of the voltage VB is the maximum control level, the automatic brightness control using the highest level of the integrated signals IR, IG, IB has no effect.

To resume, the circuit shown in FIG. 2 provides a brightness control circuit 1 in which the brightness of the lighting unit 2 is automatically controlled with the level of the integrated signal which has the highest level if this highest level is higher than the level of the voltage VB which depends on the user brightness setting. This circuit has the advantage that the available brightness range above the brightness level defined by the user defined voltage level VB is available for the automatic control of the brightness. The automatic control of the brightness is not based on a sum of all color component signals but considers the average value of all color components separately to use the one which has the highest level. This improves the behavior of the brightness control circuit 1 especially when large areas of the image displayed have a same color, such as, for example, a blue sky, a green football field or golf field, or a red sunrise.

Of course other analog or digital circuits may be used to obtain the same behavior. Alternatively the brightness control circuit may be realized using a programmed processor, which performs an operation on, for example, available RGB-signals in a digital format. This operation includes integration (averaging) of the respective RGB-signals, determining the highest momentary value, comparing this value with the reference voltage VB, and generating the lighting unit control signal BCS in a digital format. This digital format may be supplied directly to the lighting unit 2 or may be converted firstly via a digital-to-analog converter in an analog lighting unit control signal BCS.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A brightness control circuit (1) for a lighting unit (2) of a matrix display unit (3) having transmissive or reflective pixels (Pi), the brightness control circuit (1) comprises
an integrator (10) for integrating color component signals (R, G, B) of an input image signal (IS) to be displayed on the matrix display unit (3) to obtain integrated signals (IR, IG, IB), and
a selector (11) for supplying the one of the integrated signals (IR, IG, IB) having a highest level to the lighting unit (2) to obtain a brightness of the lighting unit (2) depending on said highest level.

2. A brightness control circuit (1) as claimed in claim 1, wherein the integrated signals (IR, IG, IB) comprise a first integrated signal (IR), a second integrated signal (IG), and a third integrated signal (IB) corresponding to respective ones of the color component signals (R, G, B), and wherein the selector (11) comprises
an operational amplifier (OA) having an inverting input (−) for receiving a reference voltage (VB), a non-inverting input (+), and an output connected with the non-inverting input (+) and connected to the lighting unit (2) to supply a control signal (BCS) to the lighting unit (2) determining the brightness,
a first rectifier (D1) having a cathode (CA1) coupled to the non-inverting input (+) and an anode (AN1) for receiving the first integrated signal (IR),
a second rectifier (D2) having a cathode (CA2) coupled to the non-inverting input (+) and an anode (AN2) for receiving the second integrated signal (IG), and
a third rectifier (D3) having a cathode (CA3) coupled to the non-inverting input (+) and an anode (AN3) for receiving the third integrated signal (IB).

3. A brightness control circuit (1) as claimed in claim 2, wherein the reference voltage (VB) is user-controllable for obtaining a user adjustable brightness.

4. A display apparatus comprising
the brightness control circuit (1) as claimed in claim 1,
a video processing circuit (4) for receiving the input image signal (IS) to supply an input data signal (DS),
the matrix display unit (3), and
the lighting unit (2) comprising a light source for radiating light (L) towards said display pixels (Pi).

5. A method of controlling brightness of a lighting unit (2) of a matrix display unit (3) having transmissive or reflective pixels (Pi), the method comprises
integrating (10) color component signals (R, G, B) of an input image signal (IS) to be displayed on the liquid crystal display device (1) to obtain integrated signals (IR, IG, IB), and
supplying (11) the one of the integrated signals (IR, IG, IB) having a highest level to the lighting unit (2) to obtain a brightness of the lighting unit (2) depending on said highest level.
